(19) United States
(12) Patent Application Publication
(10) Pub. No.: US 2008/0003549 A1
(43) Pub. Date: Jan. 3, 2008

(54) Method for Teaching Handwriting

(76) Inventors: Jonathan Fine, Brookline, MA (US); Kevin Lawlor, Newton, MA (US)

Correspondence Address: ARCHIBALD LLC, 25 MALL ROAD, SUITE 300, BURLINGTON, MA, 01803, US

(21) Appl. No.: 11/424,103

(22) Filed: Jun. 14, 2006

(51) Int. Cl. G09B 19/00

(52) U.S. Cl. 434/155

(57) ABSTRACT

The present invention comprises a method for the instruction of handwriting through the use of cartoon items. Certain cartoons and other drawings may be introduced and students asked to reproduce the cartoon items a number of times; until a desired proficiency is reached. Subsequently, the student may be made aware that a portion or all of the cartoon item also includes a handwriting element. The student may then be instructed in the reproduction of the handwriting element alone. Through this method the student may acquire the necessary skills to reproduce the handwriting element alone, or in combination with other handwriting elements, to achieve proficiency at reproducing the handwriting element. The end result being that handwriting may be learned efficiently in a manner that retains the students' interest.

### BACKGROUND OF THE INVENTION

1. Field of the Invention

The present invention relates generally to the field of providing teaching and instruction and particularly to a method for teaching handwriting.

2. Description of the Related Art

Many educational tools and methods of instructing students currently exist. It is often the case that to do anything properly, repetition and practice are the only means that lead to mastery of a desired skill. However, repetition is often extremely boring, causing many students to lose interest, put forth less than the appropriate effort, or even to give up completely.

Learning to master handwriting skills is a prime example of a skill that must be repeated to achieve mastery. To learn the appropriate motor skills, students are often required to painstakingly repeat certain movements. When the students are children, it is very difficult for the instructor to maintain the child's attention for the time necessary to achieve proficiency. There is little enjoyment in copying or tracing letters over and over again. Instructors are constantly challenged in coming up with new ways to keep the students' interest, yet convey the important lessons necessary for mastery.

An example of a more creative teaching method can be found in U.S. Pat. No. 2,447,213 to Sledge that discloses a teaching method for learning music through the use of colors and animals. The method employs a color code system in which each of the lines on a staff is provided with its own color. For example, the “G” line is colored blue to represent a street, and a small blue house is positioned at the end of the line. Animals are also used as markers to indicate specific notes, for example a goose would represent a “GG.” Thus, a child would be taught that a goose lives in the blue house at the end of the blue street. The child would then able to easily understand the specific lines each note is associated with.

U.S. Pat. No. 3,950,863 discloses a method of alphabet recognition and learning handwriting. The student is taught nine basic shapes, from which all the upper and lower case letters can be derived. Transparencies are also used for repetition and consistency.

U.S. Pat. No. 4,822,284 also discloses a device designed to instruct children in handwriting. The device comprises a rotatable disk with holes through which a writing instrument may be inserted. The disk is transparent so that various arcs and lines may be viewed as they are drawn. The disk is preferably rotated only in the clockwise direction to facilitate the correct formation of the desired letters.

These patents illustrate that animals and other interesting concepts may be used to increase the enjoyment level of what would otherwise be a tedious task. Although the above referenced inventions may be suitable for their desired results, they lack certain benefits provided by the present invention.

There are numerous approaches used to teach cursive writing to students. Yet there is always a need to find novel and potentially more effective methods. Therefore, what is required is a method for teaching handwriting, and in particular cursive writing that is easy to understand.

What is further required is a method for teaching cursive writing that is enjoyable for the student.

What is also required is a method for teaching handwriting that will not frustrate the student, nor overpower the students' natural desire to learn.

### BRIEF SUMMARY OF THE INVENTION

Therefore, it is an object of the present invention to provide a method of instruction that is easy to understand from the standpoint of both the instructor and the student.

It is a further object of the present invention to promote learning by providing a method that takes full advantage of students' natural tendency to want to have fun.

It is also an object of the present invention to lessen the tedious aspects that are appurtenant to classic repetitive learning methods.

### BRIEF DESCRIPTION OF THE SEVERAL VIEWS OF THE DRAWINGS

These and other features, aspects and advantages of the present invention will become better understood with reference to the following description, appended claims and accompanying drawings where:

FIG. 1 is an example of a prior art teaching aid used in standard cursive writing teaching methods.

FIG. 2 is a cartoon item demonstrating a handwriting element of the present invention.

FIG. 3 is a cartoon item demonstrating a handwriting element of the present invention.

FIG. 4 is a cartoon item demonstrating a handwriting element of the present invention.

FIG. 5 is a cartoon item demonstrating a handwriting element of the present invention.

FIG. 6 is a cartoon item demonstrating a handwriting element of the present invention.

FIG. 7 is a cartoon item demonstrating a handwriting element of the present invention.

FIG. 8 is a cartoon item demonstrating a handwriting element of the present invention.

FIG. 9 is a cartoon item demonstrating a handwriting element of the present invention.

FIG. 10 is a cartoon item demonstrating a handwriting element of the present invention.

FIG. 11 is a cartoon item demonstrating a handwriting element of the present invention.

FIG. 12 is a cartoon item demonstrating a handwriting element of the present invention.

FIG. 13 is a cartoon item demonstrating a handwriting element of the present invention.

FIG. 14 illustrates steps in a preferred embodiment of the method of the present invention.

### DETAILED DESCRIPTION OF THE INVENTION

The inventors propose a new method that teaches students initially to draw simple cartoons. These basic cartoon shapes and strokes are the basis for cursive writing. The method, which is simple to learn, is based primarily on a kinesthetic approach that most cursive programs use, but differs because of the ancillary beneficial effects. Self-esteem and increased artistic skills are just two of the many benefits of this writing approach. The present invention has already been used successfully in schools that specialize in the education of students who have special needs. The fundamental principles of the invention can also be applied to students of any age or developmental level, in one-on-one tutoring, or classes of any size.

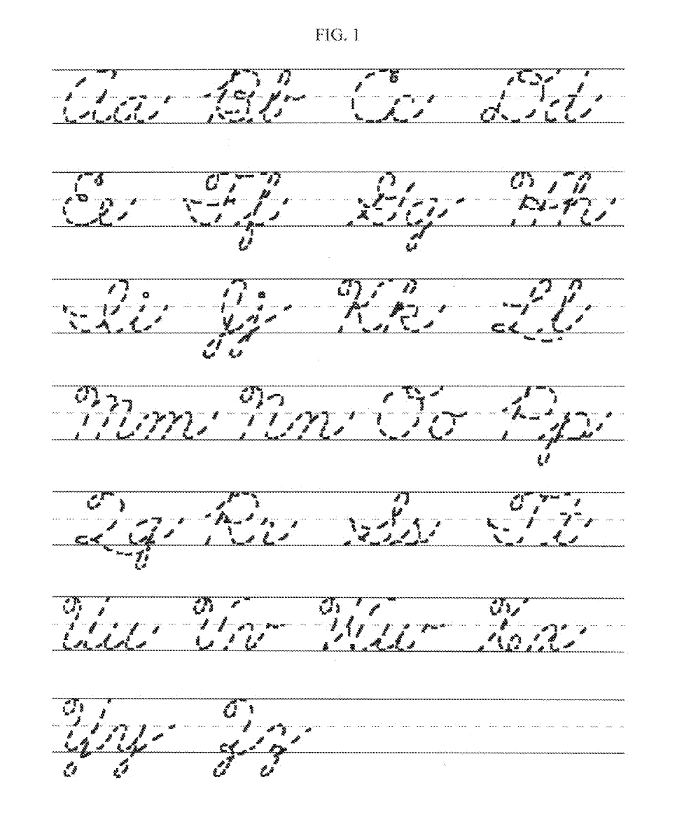

FIG. 1 represents an example of the prior art in a standard letter chart. This figure exemplifies how broken or dashed lines may be used to assist in learning the proper letter configurations. This style of instruction tends to be very rigid and does not allow for much variation or imagination. While the concept of using broken or dashed lines may be effective, those skilled in the art will recognize the rigidity that must be followed to ensure that the letters start and stop at the proper locations.

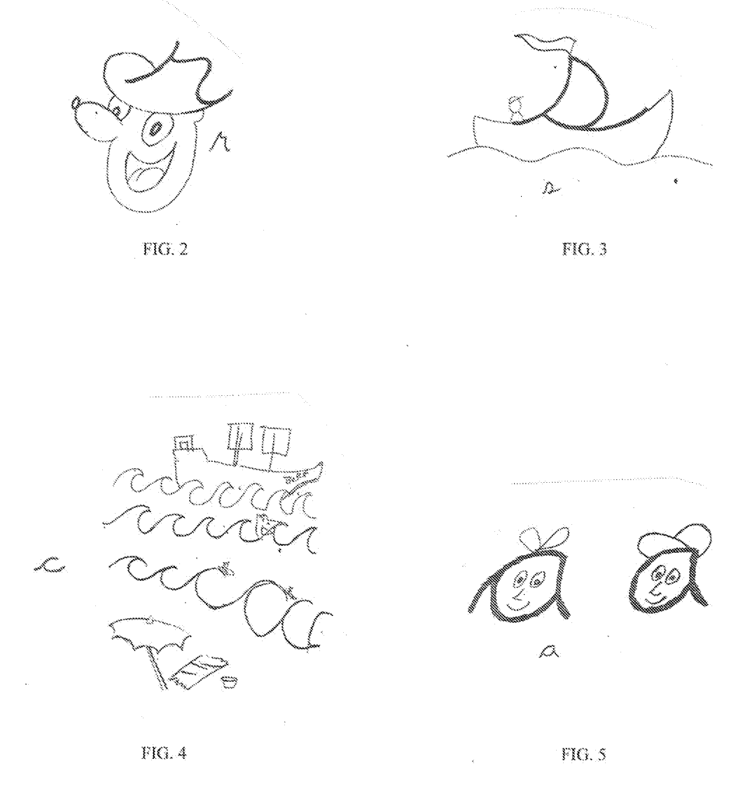

The creativity embodied in the present invention is immediately recognizable through FIG. 2. The hat in this cartoon item actually represents a lower-case cursive “r.” However, the student will be focused only on drawing the hat in the manner asked for by the instructor. As a result, the student will not be discouraged by the thought of simply repeating a letter “r” until it is done correctly.

FIG. 3 utilizes the letter “s” as the sail portion of a sail boat. In adherence to the aims of the present invention, the student is instructed first to draw the cartoon item, here a sail boat, in the manner requested by the instructor. The boat may be repeated as necessary, but it should be apparent that copying a boat is normally more interesting and fun for a student than merely copying a letter repeatedly. This figure also illustrates the embodiment where the handwriting element comprises an entire letter.

It should also be noted the broadness with which the term “cartoon item” encapsulates. It may be singular or plural, there may exist a number of components that together make up the cartoon item. Some of the components of the cartoon item may contain handwriting elements, but it is not a requirement that all do so.

FIG. 4 comprises handwriting elements in form of a letter “c,” and a ship with no handwriting elements is also present. Added components that do not contain handwriting elements may be desirable to ensure that the student truly appreciates the overall creativity within the cartoon item, thus maximizing enjoyment for the student while simultaneously learning the desired skill.

FIG. 5 may be viewed as less imaginative than some of the other embodiments of the present invention, yet, there is an added humoristic element where a somewhat recognizable handwriting element, the letter “a,” is employed in a cartoonistic way. This is the simplest embodiment of the present invention, whereby a handwriting element, in the form of a complete letter, is merely adorned with cartoonistic components such as a face, headgear or other accessories.

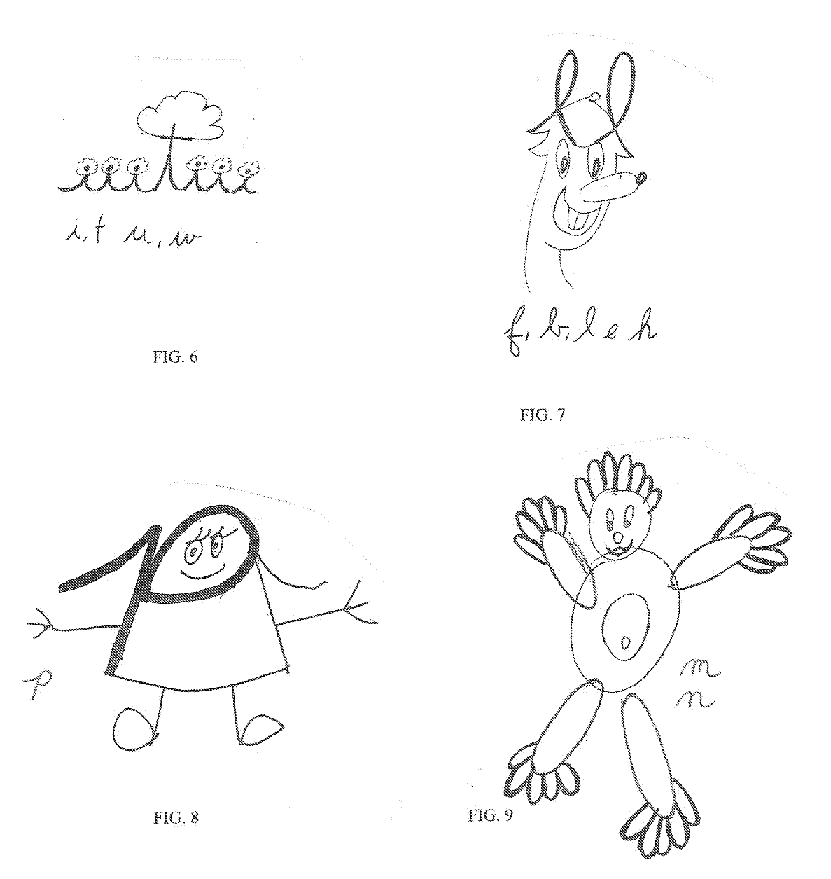

FIG. 6 demonstrates multiple handwriting elements in combination comprising a single cartoon item. Handwriting elements comprising the letters “i,” “t,” u” and “w” may be combined to form a nature scene that includes flowers and a tree. The various cartoon items, that is a tree or a flower, may also be drawn alone if desired.

FIG. 7 demonstrates an embodiment of the present invention whereby the handwriting element may comprise a complete letter “l” or “e,” or a portion of letters such as “f,” “b” and “h.”

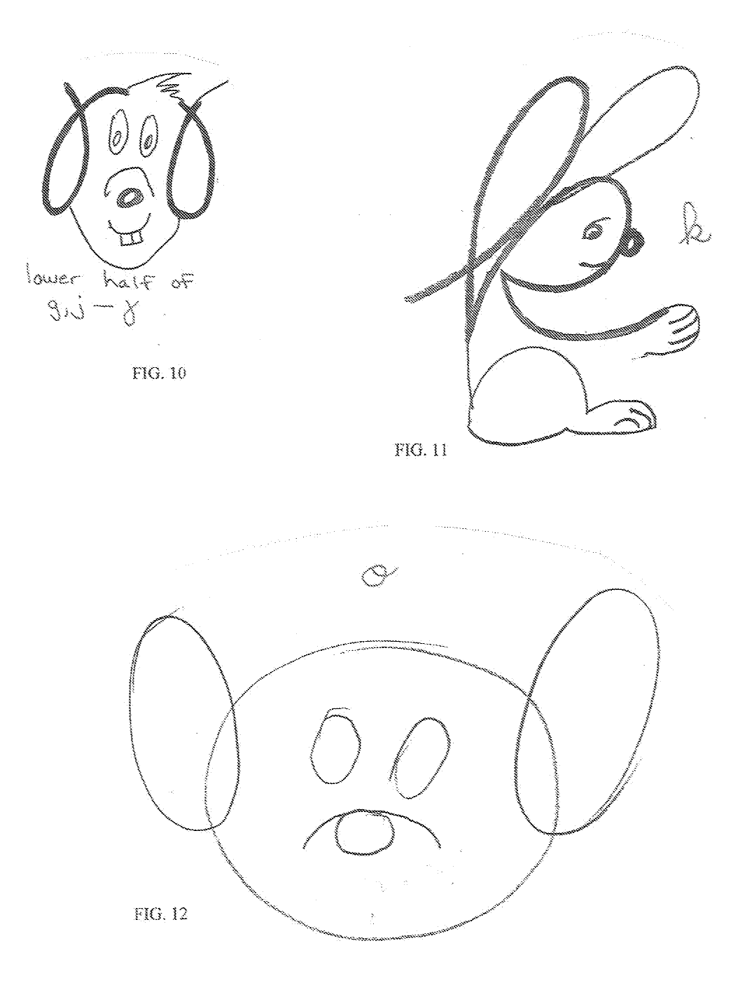

FIG. 8 demonstrates an embodiment of the present invention wherein an entire letter is part of the cartoon item, specifically a letter “p.”

FIG. 9 demonstrates an embodiment of the present invention wherein an entire letter is part of the cartoon item, specifically the letters “m” and “n,” and also the technique for forming those letters may also be practiced in part or in whole by means of drawing the fingers, toes and hair of the cartoon item.

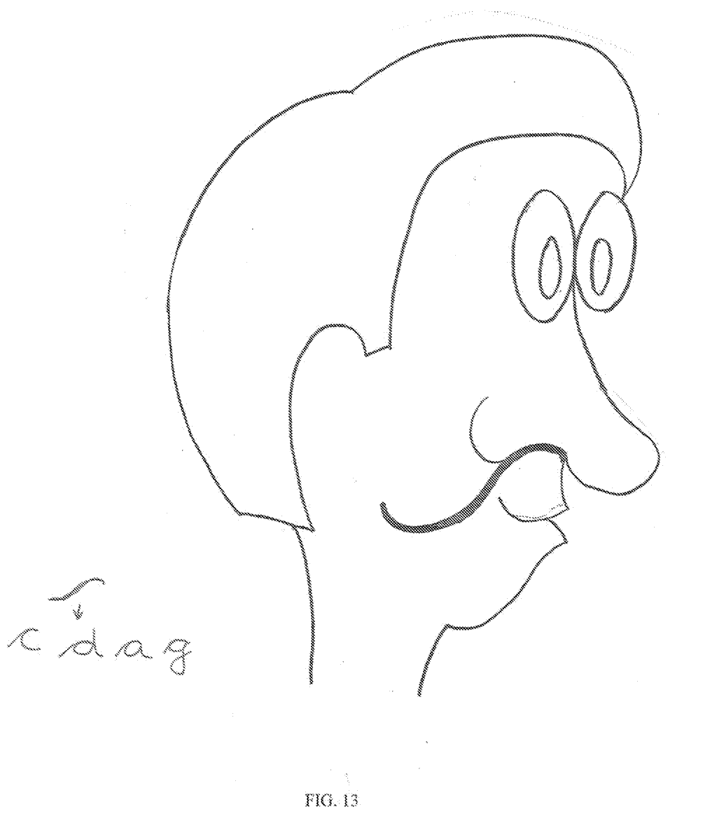

FIG. 10 demonstrates an embodiment of the present invention wherein a portion of letters such as “j” or “g” comprise a portion of the cartoon item. In this example ears of character substantially resembling a dog is shown.

FIG. 11 demonstrates an embodiment of the present invention wherein an entire letter is part of the cartoon item, specifically a letter “k.”

FIG. 12 demonstrates an embodiment of the present invention wherein portions of letters and their connecting portions (such as the extension of a letter “o”) can be utilized to form a cartoon item substantially resembling a mouse by means of eyes, nose, ears, head and the like.

FIG. 13 demonstrates an embodiment of the present invention wherein portions of letters and their connecting portions (such as the extension of letters like “o” “c” “d” “a” etc.) comprise at least a portion of a cartoon item.

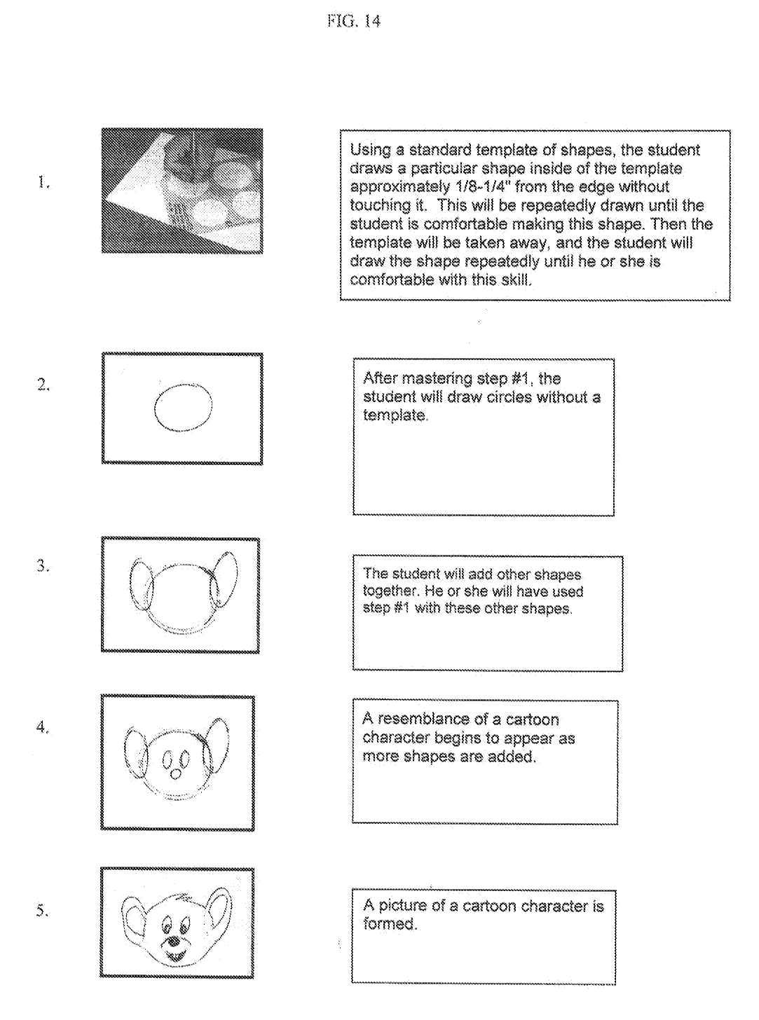

FIG. 14 illustrates a preferred embodiment of the present invention. The students first draw basic shapes such as circles, ovals, and curves. A template can be used to initially help guide the student in the forming of the shapes. The students may repeat the task until it becomes fluid. Once that skill is mastered, the student draws several of these shapes on a single sheet of paper to produce a cartoon. Students can create original cartoons or they can draw their favorite characters. Also, they can obtain ideas from cartoon-drawing books.

Teaching cursive writing to students is a significant part of the school curriculum, taught on an individual basis or as whole-class lessons. Teachers, occupational therapists, and other personnel teach these skills to children who may or may not have learning disabilities.

There are many ways to teach cursive writing, some of which are more effective than others. A particular method of writing instruction may benefit one child, but not another. Factors such as the child's interest, skills, and learning styles are extremely important. For example, a child that is a visual learner may benefit more from a teaching style that emphasizes watching the instructor form letters and then copying or imitating his or her actions. Others may learn more easily from verbal instruction and explanation.

Educators are always looking for a “best fit” for a particular student. The term “best fit” considers such factors as those noted above. Consequently, new teaching strategies are continuously being developed. This need to develop new strategies is important in all schools, and especially important in special needs schools.

A particular area of focus, but not of limitation, of the present invention is in the area of schools that specialize in the education of students with behavioral and/or emotional concerns. There are characteristics common to these students that may impede progress with their academic skills. These characteristics may include a need for immediate gratification as well as a need for a completed product or skill that the student feels is important. Many students also have difficulty with self-motivation, and the reason for not completing an assignment may be a simple lack of interest. As a result, teaching techniques for these students require innovative approaches that apply not only to regular academic studies, but to cursive writing as well. Some or all of the challenges associated with special needs students may be present in all students to varying degrees.

Teaching the students first to draw cartoons and then to perform cursive writing has been successful in the special needs forum. The present invention helps students to first learn the basic shapes used in cursive writing; and it seems to alleviate some of the problems impeding the progress of students with special needs. This approach is also consistent with the basic principles of motor learning and of learning theory.

This method may be utilized as a preparatory program for a standard cursive-writing program; the method focuses first on basic shapes but not with the actual letters. After learning this technique, students may then be introduced to a standard cursive-writing program. This method is consistent with the occupational therapy practice framework: domain and process. Students are engaging in occupation (cartoon drawing) to improve a relevant performance skill (cursive writing).

The idea of cartoon drawing to help students learn cursive was first developed after an occupational therapist observed an art teacher teaching his students to draw cartoons. The art teacher's method, which has been used for several years with much success, begins with the students using their index finger to draw shapes in the air. This approach allows the students to refine their visual perceptional skills, which are needed for more advanced drawing. Students would “draw” these shapes using large movements involving the entire arm, an aspect that the art teacher believes improves perception and motor skills.

After mastering this visual perceptional task, the students began to draw shapes on paper. First, they drew circles in the air slightly above the paper. Then, when the students felt the circle was correct, they lightly drew a circle on paper. If the shape was correct, they filled out a standard sheet of paper with circles or other shapes. The students then used these various shapes to draw cartoons, a technique commonly found in cartoon-drawing books.

The occupational therapist recognized the similarities between shapes for cartoons and those for cursive. Through collaboration between the art teacher and the occupational therapist, a new technique was developed for teaching cursive writing. First trialed on a student, D.F., this method subsequently was used with several other students.

Case Study

D.F. is a nine-year-old student who has been receiving occupational therapy to improve his writing skills. Over several years he has developed average skills with printing but has had difficulties learning cursive writing. One of the inventors of the present method had used standard writing programs in treating the student. After completing these, D.F. was able to form lower case letters in cursive; however, he had difficulty connecting the letters. His connections were sharp and pointy, with letters cramped together, contributing to words that were barely legible. Numerous methods standard to occupational therapy practice were used to help him properly form these connections. Yet despite many therapy sessions over an entire academic year, D.F. still was unable to connect letters properly in cursive.

D.F. also had difficulty forming capital letters in cursive, especially the letters D, L, I, S and G that are comprised solely of curves. When he tried to form these letters, he simply could not form any of the curves, and he would either draw a stroke in a different direction, or would substitute a curve with two lines forming a sharp point.

D.F. was then taught to make cartoon characters using basic shapes, and his cursive writing improved within a month. His connections consisted of proper concave and convex curves, making his word writing considerably neater. He was also able to form all capital cursive letters correctly. With continued practice in cartoon drawing, D.F.'s cursive writing became more consistent.

### Rationale

Successful cursive-writing programs are kinesthetically-based, which emphasize basic movement patterns of letters (Benbow, 1995). One such method, Loops and other Groups by Mary Benbow, groups letters according to their shape and stresses that students learn basic patterns of one letter and apply them to similarly shaped letters.

The inventors' approach to teaching cursive through cartoons uses a similar kinesthetic approach. Students first learn to draw basic shapes and then use these shapes to draw cartoon characters. There is a similarity between the basic strokes of cartoon drawing and those of cursive writing: circles, ovals, loops, and convex and concave curves are present in both. Students who acquire basic skills learned through cartoon drawing can apply them effectively to cursive writing. In addition, learning to draw curves helps students to connect letters as well as form them: The connections are primarily composed of convex and concave curves. This is an important attribute of the method of the present invention because many students have difficulty connecting cursive letters. Often students will crowd letters together and produce sharp pointed connections instead of smooth curves.

This method also relates to the kinesthetic approach because of its use of repetition, which is instrumental in kinesthetically-based writing programs (Benbow, 1995). Repetition is important in learning new skills (Lee, 1991). It causes basic skills to become automatic, allowing for more complex tasks to be learned (Ignico, 1994). This process is especially important in writing when the students should be focused on the content of what they are writing rather than the formation of letters which should be automatic. Mastering a skill such as cursive writing will enable a student to concentrate on grammar and style required for writing, instead of the formation of the cursive letters.

The present invention has further benefits, for it addresses common difficulties that children experience when learning cursive. The inventors have observed students who “draw” the letters rather than write them. They use short sketchy lines to draw a single character, often retracing each segment of the letter. The inventors have also noted that children who produce automatic cursive strokes tend to learn cursive more easily. Accordingly, the inventors have developed the theory, and resultant method that encapsulates the theory, that cartoon drawing allows skills to become automatic, partly because it requires the student to draw the same shape repeatedly.

This model of drawing cartoons to teach cursive to students also helps satisfy the need for a product or skill relevant to them, and the need for immediate gratification that often accompanies students with special needs. After a few short sessions of drawing shapes, students not only are able to produce a product, but they create something that they find enjoyable.

What most distinguishes this method from other cursive teaching methods may be the meaning that it provides for the students. Students are not simply drawing lines or shapes that may or may not be relevant to them, but rather drawing pictures that capture the students' interest. Research indicates that providing meaning to activities increases the effort and desired outcome (Ferguson & Trombly, 1997). Therefore, the inventors believe that the students will show greater improvement because they are likely to enjoy drawing cartoon characters. Cartoon drawing may be viewed as a fun activity and may stimulate the student to more eagerly accomplish the handwriting task.

Finally, the drawing of cartoons may have the additional beneficial aspect of improving self-esteem. Other studies have demonstrated that teaching art to inner-city students has increased their self-esteem (Unsworth, 1980).

The method of the present invention finds additional strength in the fact that is flexible enough to allow individual instructors to tailor it to their needs. The instructor can be a trained teaching professional, or even an untrained individual. The student may comprise children in a classroom setting, or any individual desirable of learning handwriting, or in improving their currents skills.

The steps of the present invention do not need to be performed in any particular order to be most effective. It is preferable, however, to introduce the cartoon item early on in the process in order to retain the idea that the instruction is going to be more of an amusing exercise rather than work for the student. In that vein, the instructor may first introduce the cartoon item. This instructor may ask the students to observe the proper way to draw the cartoon item, or may simply provide the student access to the cartoon item and ask that it be reproduced. The most effective method is to have the student observe the proper formation of the cartoon item by the instructor.

The student would then be instructed to reproduce the cartoon item. In a preferred embodiment, the cartoon item would be repeated a certain number of times. However, unlike simply repeating a letter alone, the student will enjoy the repetition of the cartoon item, not fully realizing that an array of handwriting skills is being taught.

Upon mastery of the cartoon item, or upon satisfaction of the instructor, the students' attention may be drawn toward the handwriting element portion of the cartoon item. The instructor may employ an embodiment of the present invention by subtly emphasizing the handwriting element of the cartoon item initially. This may be accomplished by slowing down the demonstration during the handwriting element portion, using different colors for different portions of the cartoon item, bolding certain elements of the cartoon item, or simply calling the students' attention to a particular element. At this point, the handwriting element may be drawn alone, apart from the cartoon item. If the handwriting element comprises a complete letter, the student may be alerted to this fact. If the handwriting element comprises a portion of a letter, the instructor may continue to demonstrate the remaining portions of the letter, indicating how the complete letter is formed.

As the student now reproduces the handwriting elements apart from the cartoon items, the student will recall the cartoon items from which the handwriting elements came. This slight shift of focus is enough to transform the exercise from one that is dull and boring, to a more fun-filled endeavor.

Another variation within the scope of the invention is the integration of classical teaching methods. Less advanced students may benefit from first tracing the cartoon items as they are introduced by the instructor. The instructor may still demonstrate the proper form for creating the cartoon item, but the student may benefit from having the added guide of the traceable item. When the handwriting elements are presented apart from the cartoon items, they also may utilize tracing methods to ensure the desired level of competency has been achieved by the student. The desired level of competency or proficiency will vary depending upon the student and the instructor. Where tracing is not desired, broken lines may also be used, as is well known in the art.

Examples of cartoon items have been given, but those skilled in the art will recognize that the versatility of the present invention allows for almost any cartoon item that the instructor, or student, wishes to use. The cartoon item may be realistic looking pictures, or completely fanciful figures and characters. The term “cartoon” is used merely to refer to a drawing of some kind, that is, something other than only the letters themselves, and is not meant to be restrictive in any sense.

The inventors' method was used with students ranging in age from 8-14 who have had difficulty learning cursive through traditional cursive writing programs. These students had various difficulties such as connecting letters, sketching letters, or writing letters with sharp edges and points instead of smooth curves. This technique was also used with students who were simply resistant to learning cursive.

After performing cartoon drawing, students show a greater willingness to learn the basic shapes of cursive than those taught with a traditional cursive method. They also more readily participated in the activity, and with a greater effort. Also, the students appeared to learn basic shapes at a faster rate and produced more accurate shapes. When the students transferred these skills to cursive writing, they produced considerably neater words and letters than in the past. The entire task was much easier and more enjoyable.

This model had been shown to be effective with students who sketch their letters, have difficulty with connecting letters, or have difficulty making smooth strokes. It has also been effective with students with behavioral problems. Some students who had lacked initiative previously would engage in cartoon drawing because they thought it was fun and interesting. This technique can be applied to schools with more mainstreamed student populations, because the technique is based on basic principles of kinesthetics and motor learning. The effectiveness of this new technique for teaching cursive writing demonstrates that alternative methods may prove to be a significant development for therapists, teachers, and parents who are closely involved with the child's academic growth.

Those skilled in the art will also recognize that the method of the present invention may be practiced via all forms of media. This includes print media, such as books, posters, cards and the like, all forms of electronic media, including computers, video, audio, and other electronics. The method does not require that the instructor be actually present with the student or students, and also does not require that the instructor be present during the instruction. For example, the method may be utilized via a computer program where the student interacts with a computer only at their own pace, or the instruction could be given via a book, teleconference, webcast, recorded material, or any other form of communication.

Although the present invention has been described with reference to particular embodiments, it will be apparent to those skilled in the art that variations and modifications can be substituted therefore without departing from the principles and spirit of the invention.

What is claimed is:

1. A method for teaching handwriting, said method comprising the steps of:
instructing a student in the drawing of shapes;
introducing a cartoon item;
instructing a student in the drawing of the cartoon item, wherein said cartoon item comprises said shapes, and said cartoon item further comprises at least one handwriting element;
directing the student to draw the cartoon item a desired number of times; and
emphasizing the handwriting element of said cartoon item.

2. The method of claim 1, wherein the step of instructing a student in the drawing of shapes further comprises providing the student with a template, wherein said template comprises basic shapes, and wherein said step of instructing a student in the drawing of shapes further comprises the student using the template as an aid in the drawing of said shapes.

3. The method of claim 2, wherein the step of instructing a student in the drawing of a cartoon item further comprises instructing the student to repeat the drawing of said basic shapes with the aid of said template until a desired proficiency is reached.

4. The method of claim 3, wherein said step of instructing a student in the drawing of a cartoon item further comprises instructing the student to reproduce the basic shapes without the aid of said template.

5. The method of claim 4, wherein the step of emphasizing a handwriting element of said cartoon item further comprises pointing out the handwriting element.

6. The method of claim 5, wherein the step of emphasizing a handwriting element further comprises the step of instructing the student to reproduce the handwriting element.

7. The method of claim 6, wherein said step of instructing the student to reproduce the handwriting element is repeated until a desired proficiency is attained.

8. The method of claim 7, wherein said handwriting element comprises at least a portion of a letter.

9. The method of claim 7, wherein said handwriting element comprises a complete letter.

10. The method of claim 9, wherein said portion of a letter further comprises a portion of a cursive letter.

11. The method of claim 9, wherein said complete letter further comprises a complete cursive letter.

12. A method for instructing a student in cursive handwriting, said method comprising the steps of:
introducing a cartoon item;
instructing a student in the drawing of the cartoon item, wherein said cartoon item includes a handwriting element;
directing the student to draw the cartoon item a desired number of times; and
emphasizing the handwriting element of said cartoon item, wherein the step of emphasizing a handwriting element of said cartoon item further comprises pointing out the handwriting element and further comprises the step of instructing the student to reproduce the handwriting element until a desired proficiency is attained;
wherein said handwriting element comprises at least a portion of a cursive letter.

13. The method of claim 12, wherein said handwriting element and said cartoon item are substantially the same.

14. The method of claim 12, wherein said handwriting element comprises a complete cursive letter.

15. The method of claim 12, wherein said cartoon item includes representations of fingers, toes or hair and wherein said handwriting element comprises a portion of a cursive letters “M” and “N.”

16. The method of claim 12, wherein said cartoon item comprises flowers, and wherein said handwriting elements include portions of cursive letters, wherein said cursive letters are selected from the group consisting of the letters “I,” “T,” “U,” and “W.”

17. The method of claim 12, wherein said cartoon item comprises ears, and wherein said handwriting element comprises the lower portion of cursive letters, wherein said cursive letters are selected from the group consisting of the letters “G” and “J.”

18. The method of claim 12, wherein said cartoon item comprises ears of a character, and said ears include portions of cursive letters, wherein said cursive letters are selected from the group consisting of the letters “F,” “B,” “E,” and “H.”

19. A method for teaching cursive writing, said method comprising the steps of:
instructing a student in the drawing of shapes using a template;
requiring the student to reproduce said shapes until a desired proficiency is attained;
instructing the student to reproduce said shapes without the use of said template;
introducing a cartoon item;
instructing a student in the drawing of the cartoon item, wherein said cartoon item comprises said shapes, and said cartoon item further comprises at least one handwriting element;
directing the student to draw the cartoon item a desired number of times; and
emphasizing the handwriting element of said cartoon item.

20. The method of claim 19 further comprising the step of instructing the student to produce cursive writing, wherein a standard cursive writing teaching methodology is used.
